(19) United States
(12) Patent Application Publication
(10) Pub. No.: US 2018/0215405 A1
(43) Pub. Date: Aug. 2, 2018

(54) FOLDABLE STROLLER

(71) Applicant: Chao Hsi LIN, Taipei City (CN)

(72) Inventor: Chao Hsi LIN, Taipei City (CN)

(21) Appl. No.: 15/547,259

(22) PCT Filed: Sep. 6, 2016
(86) PCT No.: PCT/CN2016/098206

§ 371 Date: Jul. 28, 2017

(30) Foreign Application Priority Data
Jul. 18, 2016 (CN) 201620753110.X

(51) Int. Cl. B62B 7/06; B62B 9/14; B62B 9/20

(52) U.S. Cl. CPC B62B 7/062; B62B 9/14; B62B 2205/06; B62B 2205/22; B62B 9/20

(57) ABSTRACT

The present invention discloses a foldable stroller, comprising: a front wheel support frame, a rear wheel support frame, a seat support and push rods, the lower end of the front wheel support frame is provided with front wheel assemblies, and rear wheel assemblies are arranged at the lower end of the rear wheel support frame, the push rods each are connected to the front wheel support frame and the rear wheel support frame with pivot assemblies, the foldable stroller comprises not only a first folding structure that is connected with the pivot assemblies and capable of folding the push rods, but also a second folding structure capable of folding the front wheel support frame and the rear wheel support frame. The present invention has the advantages of simple structure, low cost, convenient assembly, smooth and easy folding, small folding size and convenient collection.

### FIELD OF THE INVENTION

The present invention relates to a foldable stroller.

### BACKGROUND OF THE INVENTION

Existing stroller, comprising a stroller frame with an unfolded state and a folded state, front wheel assemblies and rear wheel assemblies disposed at the bottom of the stroller frame, a seat frame, a sunshade frame and an armrest are also disposed on the stroller frame. The folding structure in the existing strollers has the following disadvantages: complex structure, high cost, inconvenient assembly, and the folding is not smooth when the folding structure is folded, and large folding size is inconvenient for storage.

### SUMMARY OF THE INVENTION

The present invention aims to overcome the shortcomings of the prior art, provide a foldable stroller with simple structure, low costs, convenient assembly, smooth and easy folding, small folding size for convenient storage.

The present invention is implemented in such a way:

A foldable stroller, comprising: a front wheel support frame, a rear wheel support frame, a seat support and push rods, the lower end of the front wheel support frame is provided with front wheel assemblies, and rear wheel assemblies are arranged at the lower end of the rear wheel support frame, wherein the push rods each are connected to the front wheel support frame and the rear wheel support frame with pivot assemblies, the foldable stroller comprises not only a first folding structure that is connected with the pivot assemblies and capable of folding the push rods, but also a second folding structure capable of folding the front wheel support frame and the rear wheel support frame.

In the foldable stroller, each of the push rods comprises an upper push rod and a lower push rod which are pivotally connected together, the lower part of the upper push rod is provided with an upper connector, while the upper part of the lower push rod is provided with an lower connector that is pivotally connected to the upper connector of the upper push rod, the first folding structure may include a switch button disposed on the upper push rods, and the switch button is connected to first elastic latches by first ropes, and the first elastic latches are inserted into the lower push rods respectively.

In the foldable stroller, each of the pivot assemblies may include an upper pivot connecting seat connected with the lower push rod, and a lower pivot connecting seat connected with the front wheel support frame and the rear wheel support frame, the upper pivot connecting seat and the lower pivot connecting seat are pivotally connected together, the first folding structure further comprises second pull ropes connected to the upper connectors respectively, and the second pull ropes each are connected with second elastic latch, the lower pivot connecting seat is provided with a clamping groove, which is used to be inserted the second elastic latch.

In the foldable stroller, the front wheel support frame comprises upper connecting rods and lower connecting rods, the upper end of the upper connecting rods each are fixedly connected with the pivot assemblies, while the lower end of the upper connecting rods are correspondingly inserted into the lower connecting rods, the second folding structure comprises a fixed seat fixed on the lower connecting rods, and the fixed seat is provided with an elastic pull plate capable of moving forth and back on the fixed seat, a pair of tilted chutes are distributed symmetrically on the elastic pull plate, and the fixed seat is provided with cross bars capable of moving left and right on it, the cross bars of which one ends are inserted into the tilted chutes through bar heads respectively and the other ends are inserted into rod holes of the upper connecting rods correspondingly.

In the foldable stroller, the rear-end of the seat support is connected to the upper connectors through connectors of the seat support, and support rods connected with the fixed seat are hinged under the front of the seat support.

In the foldable stroller, the first elastic latch and the second elastic latch each comprise a latch body that is provided with a latch groove, and the latch groove is equipped with a latch spring, the upper end inside the latch groove is provided with a transverse hole.

In the foldable stroller, further comprising foldable transverse bars which are hinged between the front wheel support frame and the rear wheel support frame.

In the foldable stroller, further comprising a sunshade frame which is connected to the upper connectors of the pivot assemblies.

The present invention has the advantages of simple structure, low cost, convenient assembly, smooth and easy folding, small folding size and convenient collection.

### BRIEF DESCRIPTION OF THE DRAWINGS

FIG. 1 is a perspective view of an embodiment of the invention;

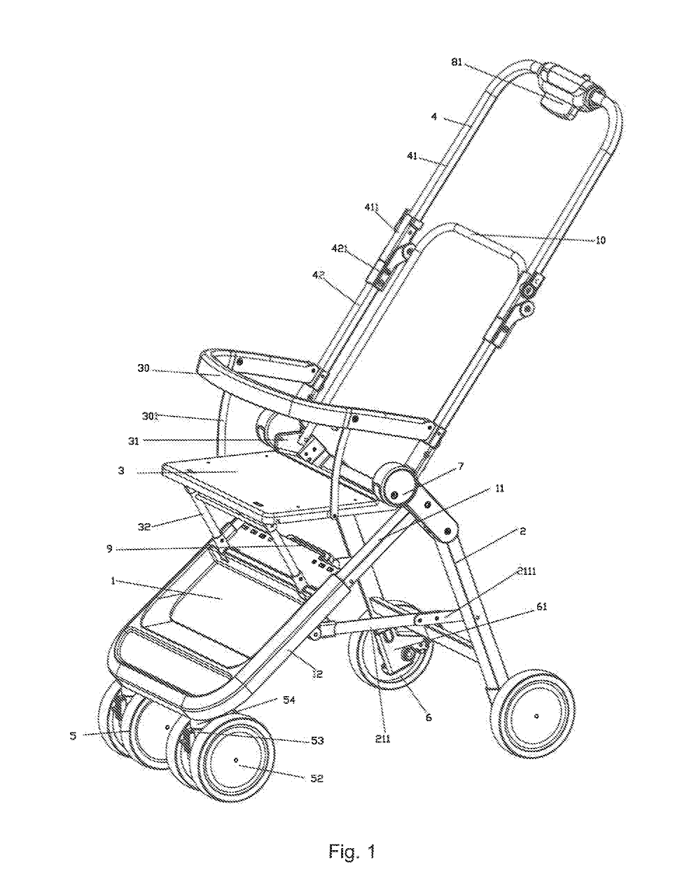

FIG. 2 is an exploded view of an embodiment of the invention;

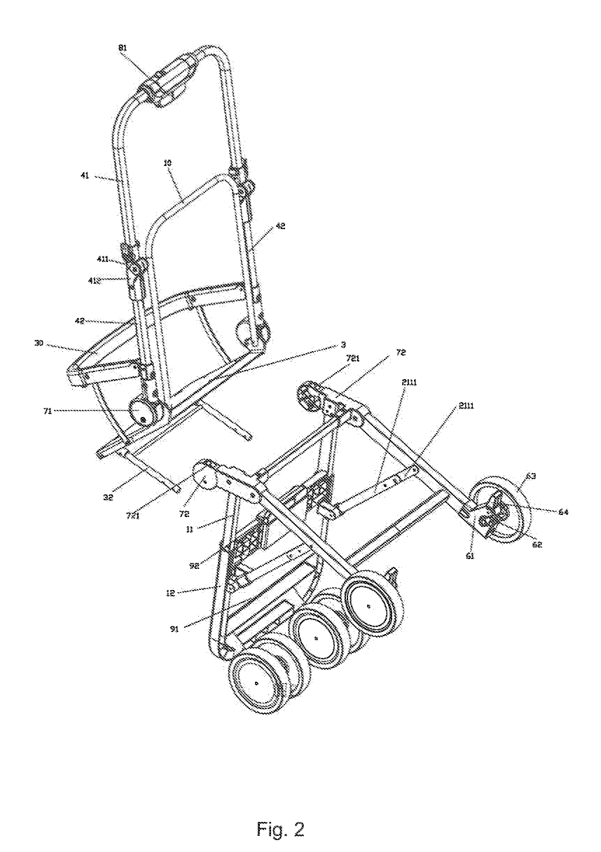

FIG. 3 is another exploded view of an embodiment of the invention from a different angle;

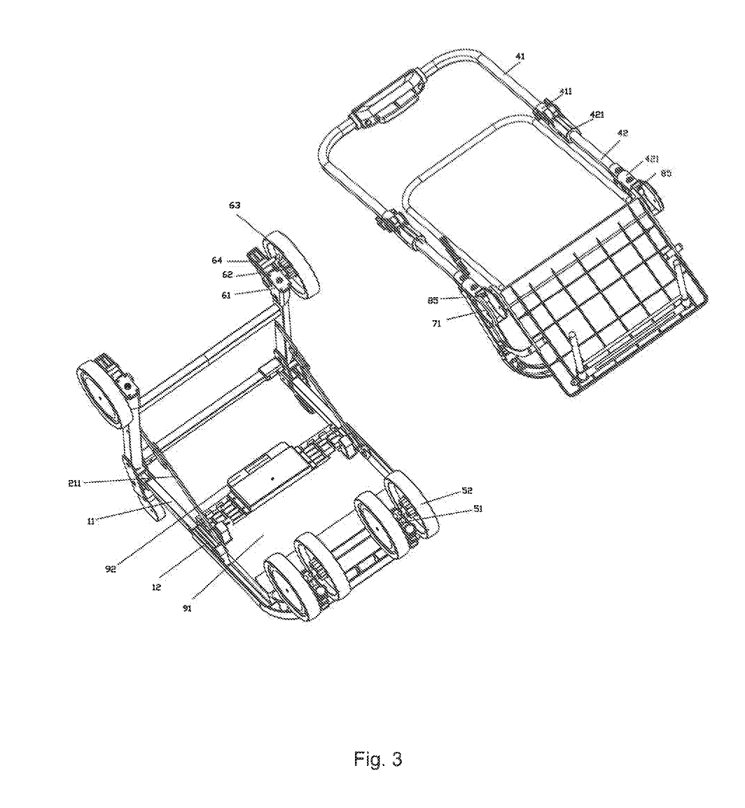

FIG. 4 is a perspective view of the first folding structure of the invention;

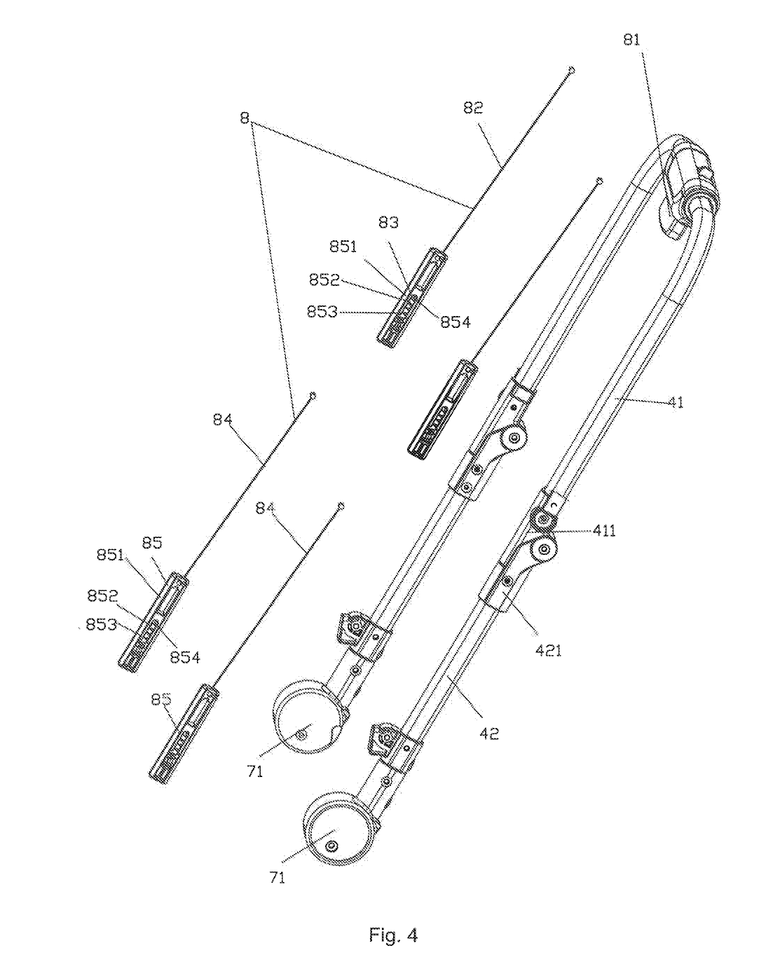

FIG. 5 is a perspective view of the front wheel support frame of the invention;

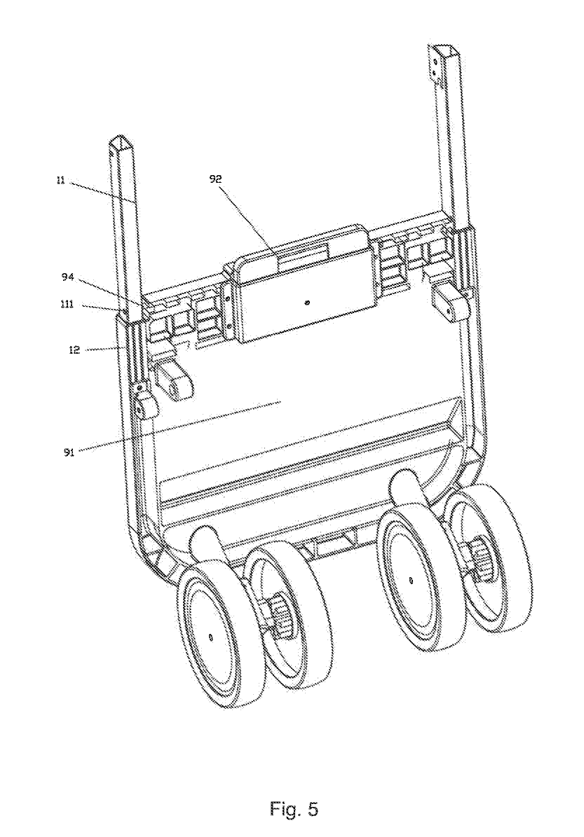

FIG. 6 is an exploded view of FIG. 5;

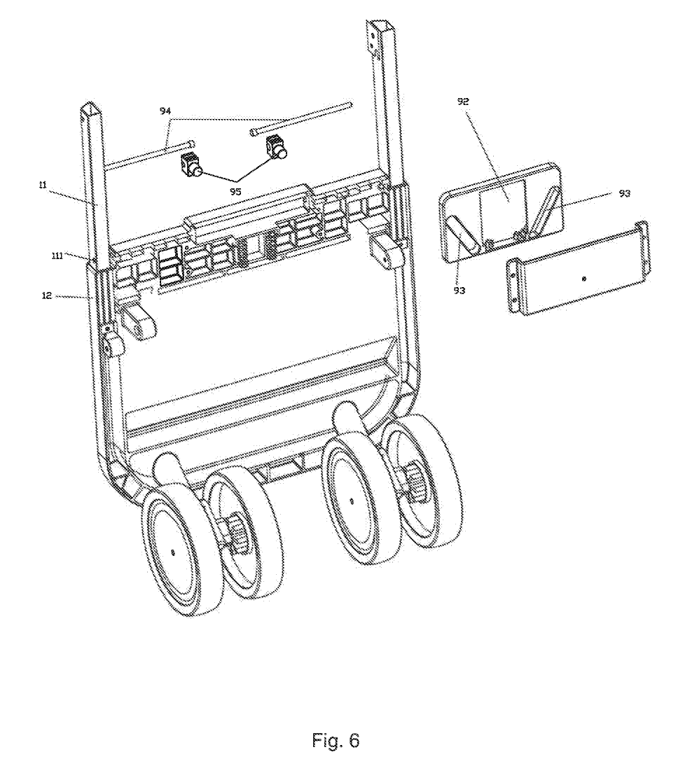

FIG. 7 is a view of the invention showing the push rods in a folded configuration;

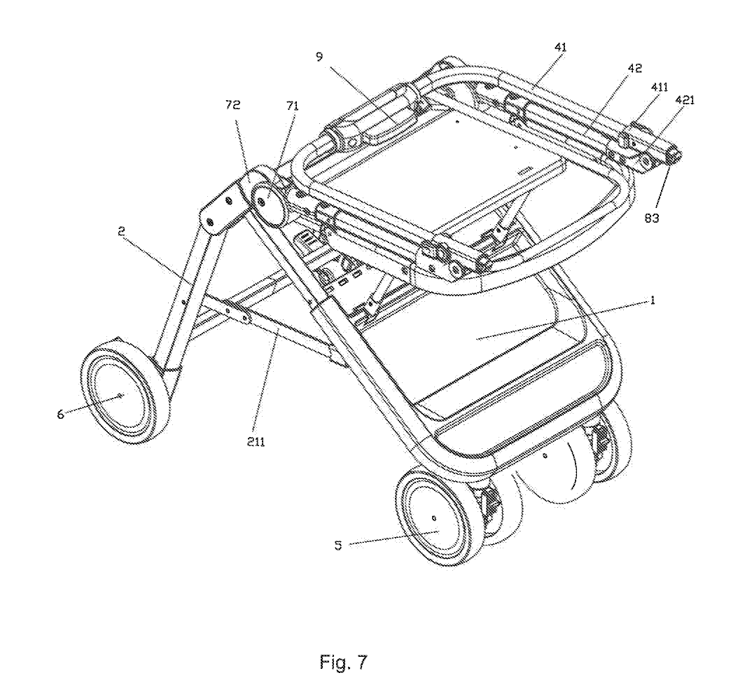

FIG. 8 is a view of the invention in the folded configuration, showing the push rods, the front wheel support frame and the rear wheel support frame all folded.

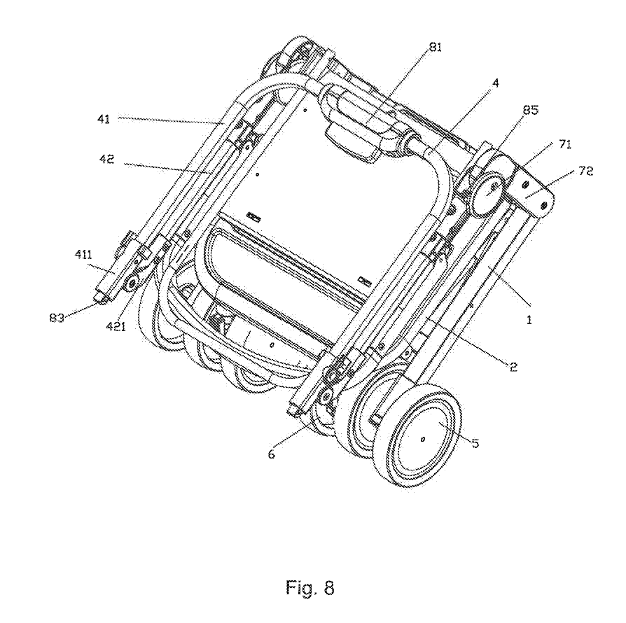

### DETAILED DESCRIPTION

The present invention will be further described below with reference to the accompanying drawings:

A foldable stroller of the present invention comprises a front wheel support frame 1, a rear wheel support frame 2, a seat support 3 and push rods 4, the lower end of the front wheel support frame 1 is provided with front wheel assemblies 5, and rear wheel assemblies 6 are arranged at the lower end of the rear wheel support frame 2, the push rods 4 each are connected to the front wheel support frame 1 and the rear wheel support frame 2 with pivot assemblies 7, the foldable stroller comprises not only a first folding structure 8 connected with the pivot assemblies 7 and capable of folding the push rods, but also a second folding structure 9 capable of folding the front wheel support frame and the rear wheel support frame. The front wheel support frame 1, the rear wheel support frame 2, the seat support 3 and the push rods 4 may be all made of hollow fittings for lightweight and cost saving, and furthermore, they may be made out of metal materials, such as stainless steel tubes, aluminum tubes or plastic tubes.

Each of the push rods 4 comprises an upper push rod 41 and a lower push rod 42 which are pivotally connected together, the lower part of the upper push rod is provided with an upper connector 411, while the upper part of the lower push rod 42 is provided with an lower connector 421 that is pivotally connected to the upper connector 411 of the upper push rods, the first folding structure 8 may include a switch button 81 disposed on the upper push rods 41, and the switch button 81 is connected to first elastic latches 83 by first ropes 82, and the first elastic latches 83 are inserted into the lower push rods 42 respectively. While pressing the switch button 81, the first ropes 82 are pulled, then the first elastic latches 83 are pulled upwards and released from the lower push rods 42, at this time, the upper connectors 411 of the upper push rods and the lower connectors 421 of the lower push rods can be rotated relative to each other so as to drive the upper push rods 41 and the lower push rods 42 to rotate respectively, thereby folding the push rods 4.

Each of the pivot assemblies 7 may include an upper pivot connecting seat 71 connected with the lower push rod 42, and a lower pivot connecting seat 72 connected with the front wheel support frame and the rear wheel support frame, the upper pivot connecting seat 71 and the lower pivot connecting seat 72 are pivotally connected together, the first folding structure 8 further comprises second pull ropes 84 connected to the upper connectors 411 respectively, and the second pull ropes 84 each are connected with second elastic latch 85, the lower pivot connecting seat 72 is provided with a clamping groove 721 for inserting of the second elastic latch 85. Keep rotating the upper push rods after the upper connectors 411 and the lower connectors 421 are relatively rotatable, the second pull ropes 84 are pulled by the upper connectors 411 of the upper push rods, and the second elastic latches 85 are pulled out of the clamping grooves 721 of the lower pivot connecting seats 72 by the second pull ropes 84. At this point, the upper pivot connecting seats 71 and the lower pivot connecting seats 72 are relatively rotatable.

Further, the front wheel support frame 1 may comprise upper connecting rods 11 and lower connecting rods 12, the upper end of the upper connecting rods 11 are fixedly connected with the lower pivot connecting seats 72 of the pivot assemblies 7 respectively, and the lower end of the upper connecting rods 11 are correspondingly inserted into the lower connecting rods 12. And foldable cross bars 211 by tow links 2111 articulated together, which are hinged between the front wheel support frame 1 and the rear wheel support frame 2.

The second folding structure 9 comprises a fixed seat 91 fixed on the lower connecting rods 12, and the fixed seat 91 is provided with an elastic pull plate 92 capable of moving forth and back on it, a pair of tilted chutes 93 are distributed symmetrically on the elastic pull plate 92, and the fixed seat 91 is provided with cross bars 94 capable of moving left and right on it. The cross bars 94 of which one ends are inserted into the tilted chutes 93 through bar heads 95 respectively and the other ends are inserted into rod holes 111 of the upper connecting rods 11 correspondingly. Pressing the elastic pull plate 92 move downwardly, the bar heads 95 slide to the centre in the tilted chutes 93 and drive the cross bars 94 to move to the centre separately, making the other ends of the cross bars 94 detached from the rod holes 111 of the upper connecting rods respectively. At this point, the upper connecting rods 11 are no longer stuck by cross bars 94 and slide downwardly by gravity into the lower connecting rods 12 separately so that achieving the folding of the front wheel support frame 1. And since the rear wheel support frame 2 is hinged to the lower pivot connecting seats 72 of the pivot assemblies 7, two links 2111 of the foldable cross bars 211 are foldable, the rear wheel support frame 2 can be rotated about the lower pivot connecting seats 72 for folding the front wheel support frame 1 and the rear wheel support frame 2.

The rear-end of the seat support 3 is connected to the upper connectors 411 through connectors of the seat support 31, and support rods 32 connected with the fixed seat 91 are hinged under the front of the seat support 3.

The first elastic latches 83 and the second elastic latches 85 each comprise a latch body 851 that provided with a latch groove 852, and the latch groove 852 is equipped with a latch spring 853, the upper end inside the latch groove 852 is provided with a transverse hole 854. The upper connectors 411 of the upper push rods and the upper pivot connecting seats 71 each are provided with a pivot inserted into the transverse hole 854 correspondingly. When The latch bodies 851 are pulled by pull ropes, once releasing the pull ropes, the latch springs 853 return in the role of the pivots respectively.

The upper connectors 411 are connected with a sunshade frame 10. Preferably, the sunshade frame 10 is pivotally connected to the upper connectors 411 so that the sunshade frame 10 can be rotated about the upper connectors 411. Further, the sunshade frame 10 is n-shaped, and a sunshade cloth can be fixed on the the sunshade frame 10.

Further, the lower push rods 42 are connected with an armrest 30, and the armrest 30 is provided with armrest links 301 which are connected to the seat support 3.

Each of the front wheel assemblies 5 comprises front wheel seat 51 that provided with a pair of wheels 52 and a connecting tube 53. The lower end of the front wheel support frame 1 is provided with connecting sleeves 54, which are connected with the connecting tubes 53 respectively.

Each of the rear wheel assemblies 6 comprises rear wheel seat 61 that provided with a rear axle 62. The rear axle 62 is equipped with a rear wheel 63 and a brake 64. Both the rear wheel seats 61 are connected with the rear wheel support frame 2.

1. A foldable stroller comprising: a front wheel support frame, a rear wheel support frame, a seat support and push rods, the lower end of the front wheel support frame is provided with front wheel assemblies, and rear wheel assemblies are arranged at the lower end of the rear wheel support frame, wherein the push rods each are connected to the front wheel support frame and the rear wheel support frame with pivot assemblies, the foldable stroller comprises not only a first folding structure that is connected with the pivot assemblies and capable of folding the push rods, but also a second folding structure capable of folding the front wheel support frame and the rear wheel support frame.

2. The foldable stroller of claim 1, wherein each of the push rods further comprises an upper push rod and a lower push rod which are pivotally connected together, the lower part of the upper push rod is provided with an upper connector, while the upper part of the lower push rod is provided with an lower connector that is pivotally connected to the upper connector of the upper push rod, the first folding structure may include a switch button disposed on the upper push rods, and the switch button is connected to first elastic latches by first ropes, and the first elastic latches are inserted into the lower push rods respectively.

3. The foldable stroller of claim 2, wherein each of the pivot assemblies further comprises an upper pivot connecting seat connected with the lower push rod, and a lower pivot connecting seat connected with the front wheel support frame and the rear wheel support frame, the upper pivot connecting seat and the lower pivot connecting seat are pivotally connected together, the first folding structure further comprises second pull ropes connected to the upper connectors respectively, and the second pull ropes each are connected with second elastic latch, the lower pivot connecting seat is provided with a clamping groove, which is used to be inserted the second elastic latch.

4. The foldable stroller of claim 1, wherein the front wheel support frame further comprises upper connecting rods and lower connecting rods, the upper end of the upper connecting rods each are fixedly connected with the pivot assemblies, while the lower end of the upper connecting rods are correspondingly inserted into the lower connecting rods, the second folding structure comprises a fixed seat fixed on the lower connecting rods, and the fixed seat is provided with an elastic pull plate capable of moving forth and back on the fixed seat, a pair of tilted chutes are distributed symmetrically on the elastic pull plate, and the fixed seat is provided with cross bars capable of moving left and right on it, the cross bars of which one ends are inserted into the tilted chutes through bar heads respectively and the other ends are inserted into rod holes of the upper connecting rods correspondingly.

5. The foldable stroller of claim 4, wherein the rear-end of the seat support is connected to the upper pivot connecting seats through connectors of the seat support, and support rods connected with the fixed seat are hinged under the front of the seat support.

6. The foldable stroller of claim 3, wherein the first elastic latch and the second elastic latch each comprise a latch body that is provided with a latch groove, and the latch groove is equipped with a latch spring, the upper end inside the latch groove is provided with a transverse hole.

7. The foldable stroller of claim 3, further comprising foldable transverse bars which are hinged between the front wheel support frame and the rear wheel support frame.

8. The foldable stroller of claim 2, further comprising a sunshade frame which is connected to the upper pivot connecting seats of the pivot assemblies.
